(19) United States
(12) Patent Application Publication
(10) Pub. No.: US 2010/0104189 A1
(43) Pub. Date: Apr. 29, 2010

(54) Handwriting Identification Method, Program And Electronic Device

(76) Inventors: Bharath ARAVAMUDHAN, Bangalore (IN); Sriganesh Madhvanath, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/331,458

(22) Filed: Dec. 10, 2008

(30) Foreign Application Priority Data
Oct. 23, 2008 (IN) 2594/CHE/2008

(51) Int. Cl. G06K 9/00; G06K 9/46; G06K 9/62

(52) U.S. Cl. 382/187; 382/190; 382/209

(57) ABSTRACT

A method of identifying at least one handwritten character composed of at least one stroke is disclosed. The method comprises providing a database comprising a plurality of sequences of strokes, the strokes of each sequence defining at least one character, at least some of said sequences comprising a plurality of strokes; capturing a string of handwritten characters, said string comprising the at least one handwritten character; and matching at least a part of the string with a sequence from said plurality of sequences. This method enables the recognition of multi-stroke characters where the positions of the strokes relative to each other are unknown or at least unreliable. A computer program product implementing this method and an electronic device comprising this computer program product are also disclosed.

### RELATED APPLICATIONS

Benefit is claimed under 35 U.S.C. 119(a)-(d) to Foreign application Serial No. 2594/CHE/2008 entitled “HANDWRITING IDENTIFICATION METHOD, PROGRAM AND ELECTRONIC DEVICE” by Hewlett-Packard Development Company, L.P., filed on Oct. 23, 2008, which is herein incorporated in its entirety by reference for all purposes.

### FIELD OF THE INVENTION

The present invention relates to a method of identifying at least one handwritten character composed of at least one stroke.

The present invention further relates to a computer program product for executing such a method.

The present invention yet further relates to an electronic device comprising such a computer program product.

### BACKGROUND OF THE INVENTION

Text input methods based on the recognition of handwritten characters using an input device such as a stylus expect that the input digital ink corresponding to a single handwritten character or a plurality of handwritten characters forming a word or a phrase, has enough information to electronically reproduce the writing. In general, this is achieved by the determination of the absolute X-Y coordinates of the stylus positions in temporal order, along with the stylus-up/stylus-down delimiters.

Handwritten characters can be composed of multiple segments or strokes. An example is for instance the letter ‘E’, which may be composed of a ‘∥’ and three ‘-’ strokes. In the context of this application, a stroke is a part of a handwritten character formed by a single, continuous motion of the hand, and for instance would be formed on paper with a pen without lifting the pen from the paper. Electronic character recognition systems that exist are capable of identifying characters composed of multiple strokes by taking the relative position of the individual strokes into consideration and deriving the character from the positional interrelation between the strokes.

Such systems may suffer from the problem that although the shapes and temporal order of the individual strokes may be known, their relative positions with respect to each other are sometimes unknown or unreliable, thus prohibiting a spatially correct electronic reconstruction of the written character, which can cause conventional electronic character recognition algorithms to fail.

For example, some devices that receive their input information from an input device such as a computer mouse or an accelerometer based remote control are incapable of capturing absolute position. Consequently, the received input information comprises the correct stroke trajectories and the correct order of the strokes of a handwritten character, but not the relative position of the strokes with respect to each other.

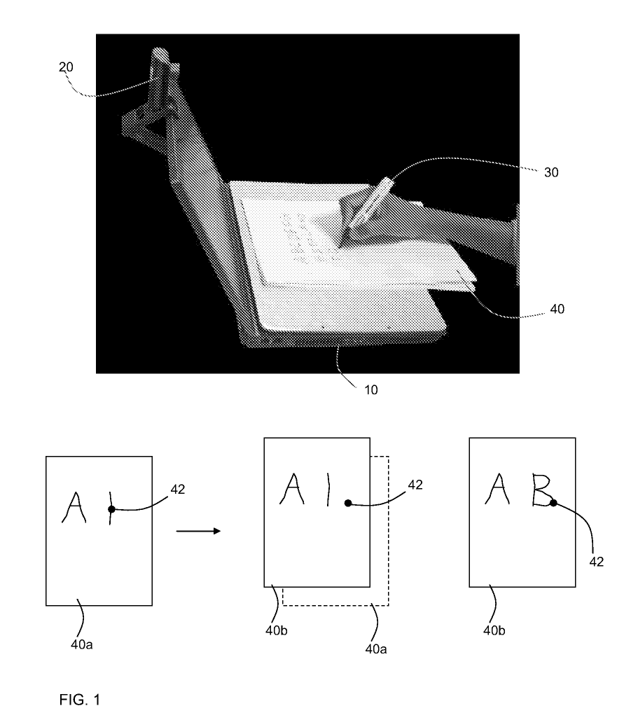

Moreover, this problem is not limited to devices incapable of capturing such relative position information, but for instance may also occur in devices that may accurately capture such relative information, but are sensitive to the introduction of errors in the capture information. FIG. 1 shows an example of a camera-based handwriting capturing device 10 such as a notebook computer, in which a camera 20 is arranged to track the movement of a pen 30 over the paper 40. In such a capturing device 10, the input ink is obtained by tracking the motion of the tip of the pen 30 in the video sequence captured by the camera 20. In this scenario, the user may inadvertently move the paper 40 from position 40a to position 40b in between writing successive strokes of a character, thus resulting in a change in the relative position of the x,y coordinate 42, which causes the introduction of an error in the relative position information of the strokes of the capital ‘B’ written on the paper 40.

This problem may be solved by registering the absolute paper position, such that the displaced paper is registered in a new video frame image, and this registered position is correlated to the paper position in the previous image in order to evaluate the offset along the X and Y directions, such that the coordinates of the captured strokes in the new video image can be adjusted accordingly. However, this solution is not trivial and the algorithms required for compensating for paper displacement may involve complex and time consuming computation.

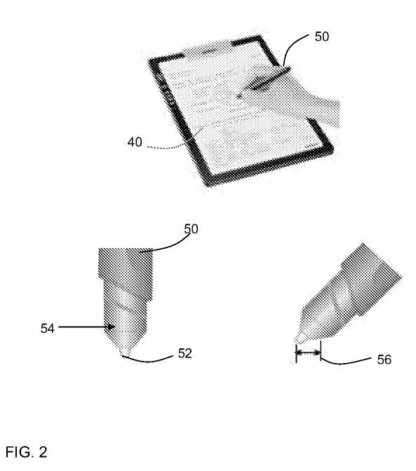

Further examples of devices that may have difficulty accurately determining the relative positions of strokes include relatively inexpensive electronic paperclip devices such as ACECAD DigiMemo as well as digitizing tablets. In such devices, an example of which is shown in FIG. 2, the sensor 54 in the pen 50 is situated a little above the pen tip 52. As a result, the coordinates captured vary as the pen position varies with the slant at which the user holds the pen 50. Even though the pen tilt may not change significantly within a stroke, it is likely to vary across strokes that form the written character(s), as demonstrated by displacement 56.

One possible solution is to model the tilt angle by calibration. During calibration, the user is made to write over some reference marks present at different locations on the paper 40. The offset between the predetermined locations of the marks and the stroke coordinates captured during the calibration process can be used to compensate for the tilt. However, the calibration process is cumbersome and time-consuming to the user, and assumes that the user continues to hold the pen with the same tilt in normal use as during calibration, which is unlikely because physical variables such as fatigue and writer's cramp will have an impact on the actual tilt. Consequently, the calibration adjustment of the stroke coordinates may not be accurate.

Hardware solutions exist to detect the pen tilt and dynamically make adjustments to the pen coordinates. However, devices incorporating such hardware solutions are relatively expensive.

Another way to overcome the loss of relative information between strokes is the use of unistroke alphabets such as Graffiti, which have a predefined set of strokes where each stroke corresponds to a writing unit, which typically is a character. Since the handwriting recognizer interprets each stroke in isolation, there is no need to determine the spatial arrangement of the strokes. A drawback of this approach is that the users are burdened with the task of learning the stroke alphabet and the style of writing in order to be able to use the system.

### BRIEF DESCRIPTION OF THE EMBODIMENTS

Embodiments of the invention are described in more detail and by way of non-limiting examples with reference to the accompanying drawings, wherein

FIG. 1 depicts a prior art handwriting recognition device;

FIG. 2 depicts another prior art handwriting recognition device;

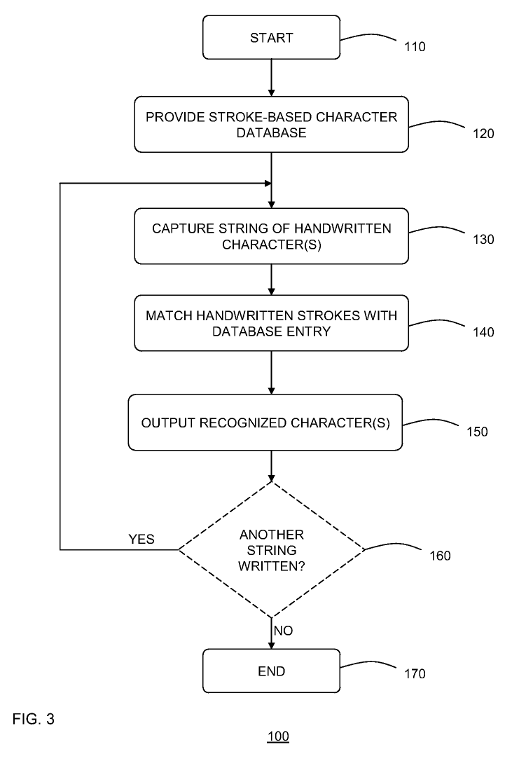

FIG. 3 schematically depicts an embodiment of a method of the present invention; and

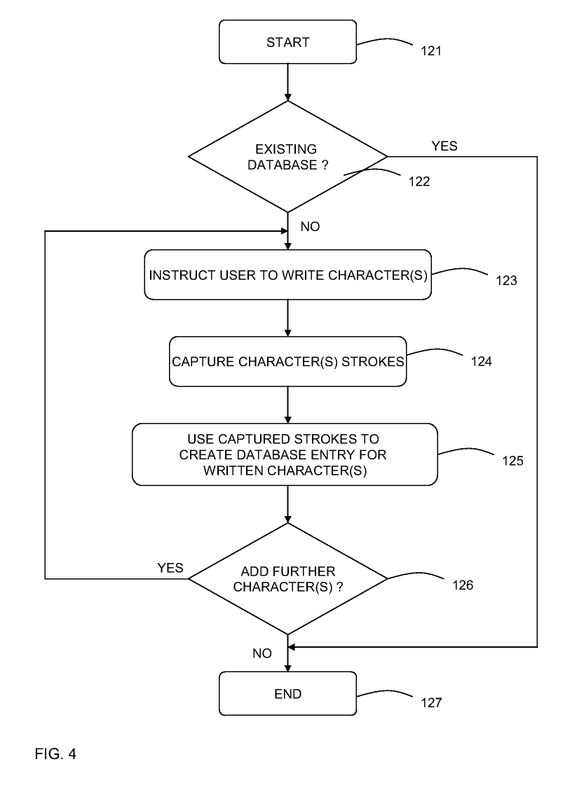

FIG. 4-7 schematically depict several aspects of embodiments of the method of the present invention in more detail.

### DETAILED DESCRIPTION OF THE DRAWINGS

It should be understood that the Figures are merely schematic and are not drawn to scale. It should also be understood that the same reference numerals are used throughout the Figures to indicate the same or similar parts.

An embodiment of the method 100 of the present invention is shown in FIG. 3. The method 100 is initiated in step 110, followed by step 120, in which a database comprising a plurality of sequences of strokes, the strokes of each sequence defining at least one character, at least some of said sequences comprising a plurality of strokes, is provided. In an embodiment, the database may comprise stroke sequences defining single characters or multiple characters such as words and phrases, or combinations thereof. An example of such a database is given in Table I:

TABLE I

| Character | Stroke sequence |
|---|---|
| A | [symbol] ; [symbol] |
| B | [symbol] ; [symbol] |
| . . . | . . . |
| b | [symbol] ; [symbol] |
| . . . | . . . |
| p | [symbol] ; [symbol] |
| Z | [symbol] |
| Z | [symbol] ; [symbol] ; [symbol] |

Typically, each character, or sequence of characters such as a word or phrase, is represented by a database entry, which further comprises the strokes in the handwriting used to form the character or sequence of characters. Such a database may be provided in any suitable way. Each character is defined by a sequence of strokes, i.e. writing motions. Each sequence comprises at least one stroke. The strokes may be defined in any suitable way, e.g. by means of a plurality of (normalized) Cartesian coordinates or, more preferably, by means of stroke feature information. This will be explained in more detail later.

In an aspect of an embodiment of the method of the present invention shown in FIG. 4, the step 120 of providing this database is initiated in step 121, after which it is checked in step 122 if a database is already present for the person providing the handwriting. If this is not the case, the method may proceed to step 123 in which this person is requested to write a character or a plurality of characters such as a word or phrase, e.g. using a stylus, computer mouse, accelerometer based remote control and so on, with the method being arranged to capture the different strokes that form the requested character or characters in step 124, after which a database entry is created in step 125 in which the character or characters are defined by the strokes captured in step 124.

Next, it is checked in step 126 if further characters need defining. If this is the case, the method returns to step 123; otherwise the method terminates in step 127. Obviously, the created database may be saved prior to termination of the method. In case it is determined in step 122 that a database is already in existence, the method may immediately proceed to termination step 127.

The above embodiment of the method of providing such a database is a non-limiting example of such a method, and it will be apparent to the skilled person that alternative methods are readily available. For instance, the user may indicate that he or she has a habit of writing the same character(s) in different ways, which triggers the method to ask the user to define the same character(s) in a different manner. This is for instance shown in Table I, where the letter ‘Z’ has been defined in two different ways. The first instance of the letter Z has been defined by a single stroke, whereas in the second instance, the same letter has been defined by three separate strokes. In the first instance, the letter Z has been written in a single fluent motion, thus yielding a single stroke, whereas in the second instance the letter Z has been written by making three straight, separate strokes, like the fictional character Zorro would write a ‘Z’.

The database may also comprise character definitions from a plurality of different users instead of being user-specific. The database may also be extended during instead of prior to handwriting recognition, as will be explained in more detail later. Further variations will be apparent to the skilled person.

Now, upon returning to FIG. 3, the method 100 proceeds to step 130, in which a string of handwritten characters comprising handwritten strokes is captured. Such a string may comprise a single character or multiple characters such as a word or a phrase. In other words, step 130 concerns with the electronic recognition of the handwriting of a person writing using an input device such as a stylus, computer mouse, accelerometer based remote control and so on, from which the strokes made with the input device can be captured either directly or indirectly, e.g. using a camera as shown in FIG. 1. The end of a string may be determined in any suitable way, e.g. by determining that the input device is kept stationary for longer than a predefined time period or by user-intervention, e.g. a manual input to indicate completion of a string.

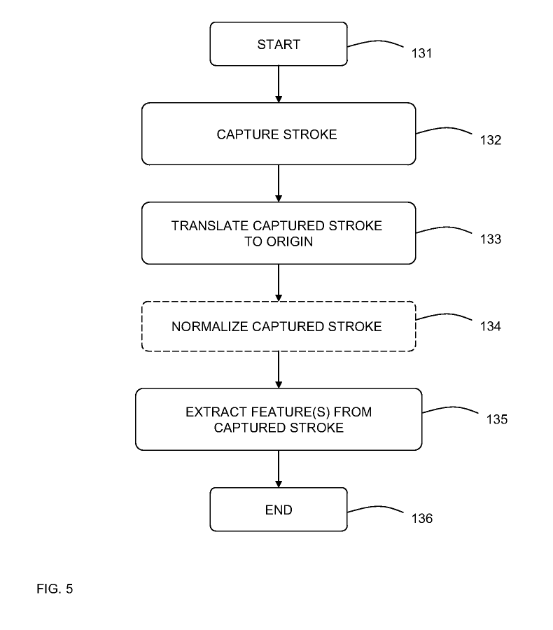

FIG. 5 shows an embodiment of the capturing step 130. Upon initiation step 131, a stroke is captured in step 132. Such a stroke may for instance be captured in terms of a series of (x,y) coordinates. In accordance with a preferred embodiment of the capturing step 131, the method proceeds to step 133, in which the centre of the bounding box of the stroke is translated to a fixed (x,y) coordinate such as the origin of a Cartesian coordinate frame, after which the method may proceed to optional step 134, in which the repositioned stroke is scaled to a fixed dimension, i.e. normalized, to account for possible size variations. Consequently, because each stroke is repositioned at a fixed coordinate, the string of input handwriting is converted to a sequence of strokes wherein each stroke is written at the same location. This effectively means that the position information of each stroke is discarded, such that compensation or post-processing techniques to eradicate stroke position errors that may creep in during (e.g. in between) the capturing of multiple strokes are no longer necessary. In other words, rather than trying to recognize a character based on the positional relationship between captured strokes, an embodiment of the method of the present invention identifies a string of characters based on the sequential nature of the strokes forming this string.

The method subsequently proceeds to step 135, in which the characteristic features of the captured stroke are extracted. For electronic handwriting recognition, features are often extracted from the points along the stroke trajectory. This is for instance necessary because there will be always subtle variations between corresponding strokes of the same character written at different occasions, whereas the features defining these corresponding strokes will remain the same. Hence, the feature information extracted from a stroke can be a more reliable reference than the stroke information itself.

If step 133 (and optionally, step 134) is carried out as described above, common features used by conventional handwriting recognizers may be extracted at each point. Alternatively, translation-invariant features such as the angle and the change in angle at each point may be used. This for instance allows for the recognition of character strings that have been written in a cursive manner. It will be appreciated that the strokes in the various stroke sequences in the database provided in step 120 may be represented in terms of the stroke features as extracted in step 135. In an embodiment, steps 132-135 may therefore be sub-steps of step 124.

Upon returning to FIG. 3, the method 100 proceeds to step 140 in which the at least one handwritten character is identified by matching at least a part of the string with a sequence from said plurality of sequences once the strokes are pre-processed and the stroke features are extracted. It is pointed out that any suitable algorithm may be used for this matching step, e.g. any continuous recognition algorithm presented in the literature may be used for recognizing the handwriting.

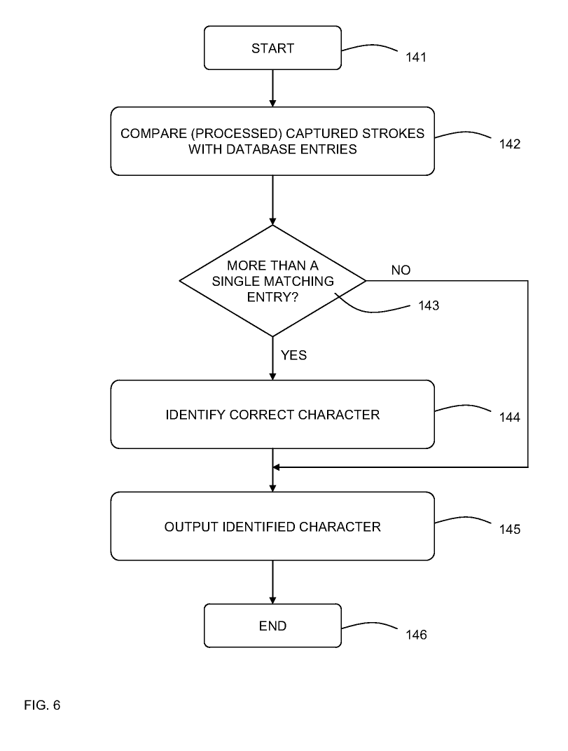

An example embodiment of step 140 is given in FIG. 6. The matching step is initiated in step 141, after which the handwritten strokes that have been captured and processed in step 130 are compared in step 142 with the stroke sequences in the database provided in step 110. As previously mentioned, the stroke sequences in the database may comprise a sequence of stroke features for each character such that said comparison step 142 comprises comparing the stroke features extracted from the handwritten strokes captured in step 130 with the stroke feature sequences stored in the database.

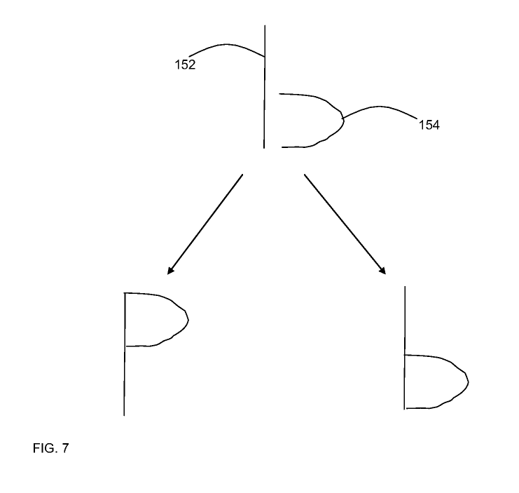

In case a sequence of strokes (or stroke features) captured in step 130 match a single database entry only, which is checked in step 143, the method may progress to step 145 in which the identified character, word or phrase, is provided as an output of the method 100. However, it may be that in step 143 it is determined that the captured strokes or stroke features correspond to more than one character in the database. An example is shown in FIG. 7, in which the processed strokes 152 and 154 may form part of the character ‘p’ as well as the character ‘b’. It will be appreciated that this is a consequence of the discarding of the positional correlation between different strokes of a handwritten character in the recognition process.

In such as case, the method will proceed to step 144, in which the correct character(s), i.e. the character(s) likely to have been written by the user, is identified. Such identification may be done in any suitable way. For instance, contextual information in the form of lexicons and language models may be used for disambiguation. This is for instance particularly advantageous if multiple word or phrase matches have been identified. In an embodiment, a lexicon check is used as a first approach. If this does not enable a selection, a language model or a phrase context model may be used as a subsequent approach for such disambiguation purposes.

Alternatively, the user can be prompted with a list of recognition choices to select from. Other identification methods will be apparent to the skilled person. Upon identification of the intended character(s), the method proceeds to step 145 as previously explained after which the matching method 140 terminates in step 146.

It will be appreciated that alternative embodiments of step 140 will be apparent to the skilled person. For instance, different parts of a captured string of handwriting may be matched by different database sequences such that the matched string is a sequence of characters extracted from multiple database sequences.

Upon returning to FIG. 3, the method 100 continues with an output step 150 in which the recognized characters are presented to the user, i.e. the writer of the handwriting. Step 150 may be omitted if the output step 145 is presented to the user rather than stored as an intermediate result. Step 150 may be followed by a checking step 160 in which it is checked if the handwriting has been completed. This check may be simply establishing that the user has continued writing, and may be conducted automatically.

If the handwriting has not yet been completed, the method 100 may return to step 130 for capturing the strokes of the next handwritten character. Otherwise, the method 100 may terminate in step 170. It will be appreciated that step 150 and 160 may also be interchanged such that the recognized handwriting is only presented to the user after the user has completed the handwriting. Also, step 170 may revert back to step 140 instead of step 130, for instance when step 130 and step 140 are being executed in parallel. Other alternative embodiments will be apparent to the skilled person.

The various embodiments of the method of the present invention may be incorporated in a computer program product that, when executed on a computer processor, causes the execution of the steps of these various embodiments. Since the algorithms required for implementing the various steps of these embodiments are readily available to the skilled person, these algorithms are not explained in further detail for reasons of brevity only.

Such a computer program product may be made available on any suitable computer-readable medium, such as a CD-ROM, DVD, floppy disk, memory stick, an internet-accessible storage device such as the hard disk of an internet server and so on.

The computer program product may be advantageously installed on an electronic device comprising a processor for executing the computer program product, for instance in the permanent memory, e.g. ROM or flash memory or on the hard disk of such a device. Alternatively, the computer program product may be embedded in the hardware of such a device. Implementation in hardware is a routine skill for the person skilled in the art, which is why this will not be explained in further detail for reasons of brevity only.

Suitable devices include personal computers, e.g. notebooks, game consoles such as the Nintendo Wii™, digital personal assistants having writing tablets and so on. Such devices may further include an input device for monitoring the writing of a character comprising at least one stroke, the input device being arranged to provide the processor with said monitoring result. Non-limiting examples of such an input device include a computer mouse, an accelerometer-based remote control such as a Wiimote™ or a camera for registering the writing motions of a stylus.

It is pointed out that a user of a device in accordance with an embodiment of the present invention no longer needs to attempt to accurately write characters, e.g. letters, on a medium with an input device. For example, it becomes possible to enter text by writing conventionally in the air using accelerometer-equipped mobile devices or a Wiimote™. Users may even choose to ignore the spatial layout of the strokes that form a written character because this layout is ignored in the method of the present invention anyway.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method of identifying at least one handwritten character composed of at least one stroke, the method comprising:
providing a database comprising a plurality of sequences of strokes, the strokes of each sequence defining at least one character, at least some of said sequences comprising a plurality of strokes;
capturing a string of handwritten characters, said string comprising the at least one handwritten character; and
matching at least a part of the string with a sequence from said plurality of sequences.

2. The method of claim 1, wherein the string comprises at least two strokes, and wherein the exact positions of the at least two strokes relative to each other are unknown.

3. The method of claim 2, further comprising translating each stroke of the string to a predefined reference prior to said matching step.

4. The method of claim 2 or 3, further comprising normalizing the sizes of the respective strokes prior to said matching step.

5. The method of claim 1, further comprising matching the string with at least two sequences from said database and selecting one of the at least two sequences by analyzing the context of the string.

6. The method of claim 1, further comprising matching the string with at least two sequences from said database, providing the writer with a list comprising the characters corresponding to the at least two sequences, and selecting one sequence based on feedback received from the writer.

7. The method of claim 1, wherein each stroke in said sequences is represented by stroke feature information, and wherein said capturing step further comprises extracting stroke feature information from the at least one stroke in said string.

8. A computer program product for identifying at least one handwritten character composed of at least one stroke, the computer program product comprising a database comprising a plurality of sequences of strokes, the strokes of each sequence defining at least one character, at least some of said sequences comprising a plurality of strokes, said computer program product being arranged to, when executed on a computer, perform the steps of:
capturing a string of handwritten characters, said string comprising the at least one handwritten character; and
matching at least a part of the string with a sequence from said plurality of sequences.

9. The computer program product of claim 8, wherein the string comprises at least two strokes, and wherein the exact positions of the at least two strokes relative to each other are unknown.

10. The computer program product of claim 9, further being arranged to perform the step of translating each stroke of the string to a predefined origin prior to said matching step.

11. The computer program product of claim 9 or 10, further being arranged to perform the step of normalizing the sizes of the respective strokes prior to said matching step.

12. The computer program product of claim 8, further being arranged to match the string with at least two sequences from said database and select one of the at least two sequences by analyzing the context of the string.

13. The computer program product of claim 8, further being arranged to match the string with at least two sequences from said database, provide the writer with a list comprising the characters corresponding to the at least two sequences, and select one sequence based on feedback received from the writer.

14. The computer program product of claim 8, wherein each stroke in said sequences is represented by stroke feature information, and wherein said capturing step further comprises extracting stroke feature information from the at least one stroke in said string.

15. An electronic device comprising the computer program product of claim 8, a processor for executing the computer program product and an input device for monitoring the writing of a character comprising at least one stroke, the input device being arranged to provide the processor with said monitoring result.
